(19) United States
(12) Patent Application Publication
(10) Pub. No.: US 2003/0046227 A1
(43) Pub. Date: Mar. 6, 2003

(54) Method and system for instruction of fund transfer

(75) Inventors: Takashi Yamagishi, Yokohama (JP); Soichiro Uchida, Yokohama (JP); Sinichiro Inoue, Kawasaki (JP); Tetsuo Matoba, Kawabe (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/062,820

(22) Filed: Jan. 30, 2002

(30) Foreign Application Priority Data
Aug. 31, 2001 (JP) 2001-262651

(51) Int. Cl. G06F 17/60

(52) U.S. Cl. 705/40

(57) ABSTRACT

A center apparatus includes recording units connected to a remitter terminal and financial agency apparatuses. The center apparatus receives the remittance information containing the customer identification information, a remittance amount desired to be remitted by the remitter, a receipt date which is a time limit date of payment and a remittee account and extracts an account possessed by the remitter from the customer data recording unit on the basis of the customer identification information, extracting transmission processing methods capable of making remittance to the remittee account from the extracted account until the receipt date on the basis of the transmission term stored in the term recording unit, selecting to provide one of the extracted transmission processing methods on the basis of the charge stored in the charge recording unit.

### BACKGROUND OF THE INVENTION

The present invention relates to a method and system for instruction of fund transfer and more particularly to a method and system for instructing a remitting financial agency to transfer a fund.

As a technique using any communication measures to utilize various services of a financial agency such as a bank from a distant place, there is an on-line banking (also referred to as an electronic banking). The on-line banking can be classified into a home banking and a firm banking for corporations and when the on-line banking utilizes the Internet as the communication measures, it is named an Internet banking (in the present specification, these are generically named an electronic fund transfer system or method).

In the electronic fund transfer system, when a remitter such as a corporation instructs a financial agency such as a bank to remit a fund (hereinafter referred to as remittance request) by means of transfer or postal transfer, its transmission processing method can be classified broadly into two methods including a batch file transmission processing method and a real-time transmission processing method. The batch file transmission processing method is a method in which data are collected during a fixed period of time (or a fixed amount of data are collected) and the collected data are processed en block or collectively and which is effective for processing of a large number of data collected during the fixed period. Further, in the real-time transmission processing method, each time data is produced, the data is processed.

When the remittance request is transmitted by the batch file transmission processing method, an amount of data to be transmitted once is increased vastly. Accordingly, a remitter must transmit the remittance request to a financial agency apparatus which is a remittance transaction apparatus installed by a financial agency a predetermined term (remittance term) before a receipt date (the date that the balance at the account of a remittee is increased in response to the remittance request of the remitter). The remittance term is variously different depending on a kind of remittance service to be requested and a remitting financial agency or a financial agency managing the account of the remittee. The kind of remittance service includes, for example, transfer of salary, comprehensive transfer and the like.

On the other hand, in the case of the real-time transmission processing method, the financial agency apparatus processes the remittance request each time the remittance request is received, while the reception of the remittance request is limited during operation of the financial agency apparatus.

Further, the commission or charge relating to the remittance transaction is different depending on a remitting financial agency or a transmission processing method of the remittance request.

Moreover, information required to be inputted at the time of preparation of the remittance request is also different depending on the transmission processing method and a utilized transmission route of a plurality of transmission routes even if the transmission processing method is the same.

Accordingly, when the above-mentioned electronic fund transfer system is utilized to send the remittance request, the remitter selects the remittance transaction method (selection of the batch file transmission processing method or the real-time transmission processing method and any of a plurality of transmission routes) in consideration of the remittance term and the remittance charge and inputs information items required for the selected remittance transaction method. The Inventor found a problem that the preliminary work at the preceding step of the remittance request preparation is very complicated when the remitter has a plurality of accounts or when there are a plurality of remittance requests, for example, and it is not clear whether the selected remittance transaction method and account of the remitter are proper economically or not.

### SUMMARY OF THE INVENTION

It is an object of the present invention to reduce the preliminary work and the preparation work of remittance request data of the remitter in the remittance request using the electronic fund transfer system.

The object of the present invention is realized by a center apparatus including recording units connected to a remitter terminal and financial agency apparatuses, the recording units including a customer data recording unit for storing customer identification information for identifying a customer and account identification information possessed by the customer so that the customer identification information corresponds to the account identification information, a term recording unit for storing, for each financial agency, a transmission term of remittance request information to the financial agency apparatus for each transmission processing method which is a method of transmitting the remittance request information to the financial agency apparatus, and a charge recording unit for storing, for each financial agency, charge required for remittance request by each transmission processing method, the center apparatus receiving the remittance information containing the customer identification information, a remittance amount desired to be remitted by the remitter, a receipt date which is a time limit date of payment and a remittee account, extracting an account possessed by the remitter from the customer data recording unit on the basis of the customer identification information, extracting transmission processing methods capable of making remittance to the remittee account from the extracted account until the receipt date on the basis of the transmission term stored in the term recording unit, selecting to provide one of the extracted transmission processing methods on the basis of the charge stored in the charge recording unit.

Moreover, the center apparatus includes an additional information recording unit for storing the transmission processing method and additional information which is information required for remittance request in each transmission processing method and is not contained in the remittance information in corresponding manner to each customer and extracts additional information stored in corresponding manner in the additional information recording unit on the basis of the transmission processing method selected as above, preparing the remittance request information on the basis of the extracted additional information and the remittance information to transmit it the financial agency apparatus.

### BRIEF DESCRIPTION OF THE DRAWINGS

FIG. 1 is a schematic diagram illustrating an electronic fund transfer system according to an embodiment of the present invention;

FIG. 2 shows a definite example of a term recording unit 136 used in the electronic fund transfer system of FIG. 1;

FIG. 3 shows a definite example of a charge recording unit 137 used in the electronic fund transfer system of FIG. 1;

FIG. 4 shows a definite example of additional information stored in an additional information recording unit 138 used in the electronic fund transfer system of FIG. 1; and

FIG. 5 is a flow chart explaining processing of the embodiment of the electronic fund transfer system of FIG. 1.

### DESCRIPTION OF EMBODIMENTS

An embodiment of the present invention is now described by way of example with reference to the accompanying drawings.

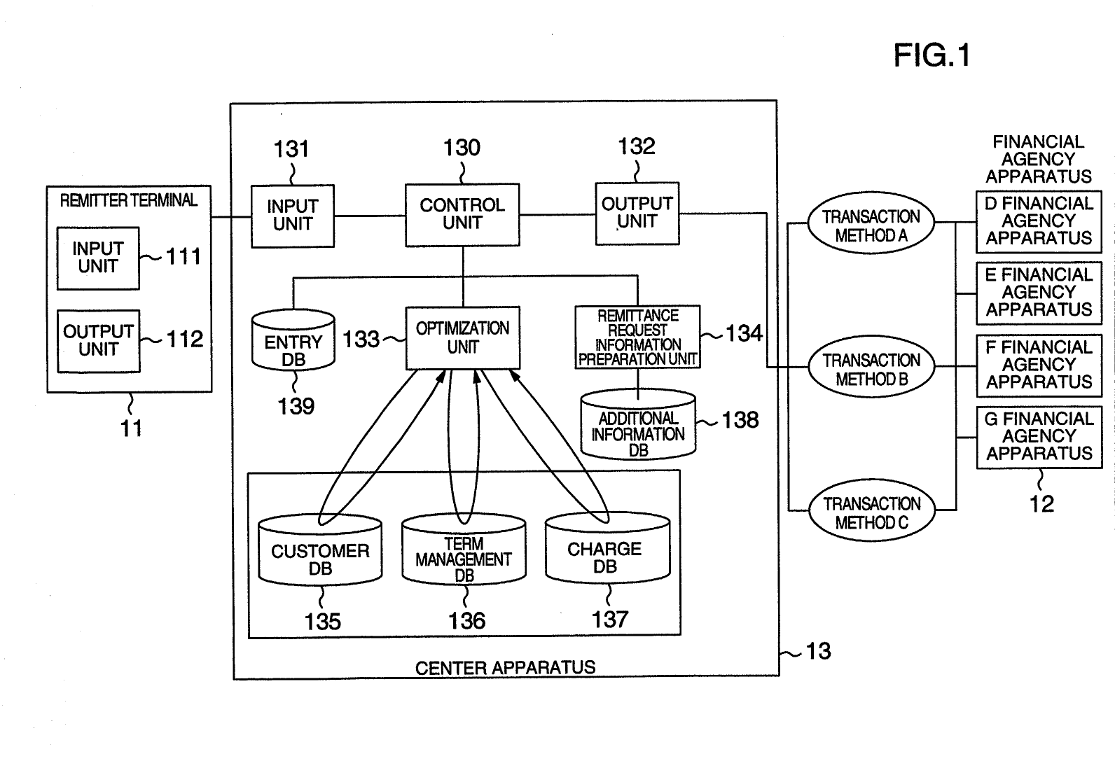

FIG. 1 is a schematic diagram illustrating an electronic fund transfer system according to an embodiment of the present invention. The electronic fund transfer system of the embodiment includes a center apparatus 13, a user terminal 11 and financial agency apparatuses 12 connected through a network such as the Internet.

The remitter terminal includes an input unit 111 such as a keyboard or a mouse and an output unit 112 such as a display or a printer. The remitter inputs remittance information by means of the input unit 111.

The remittance information is information showing the contents of remittance requested by the remitter and includes customer identification information for identifying the remitter and information indicating a receipt date, an amount of remittance, a kind of service and an account of a remittee (in the embodiment, the remittee account information includes financial agency identification information for identifying a financial agency, branch office identification information for identifying a branch office or a business office of the financial agency specified by the financial agency identification information, and kind-of-account information for specifying a kind of the remittee account, and account identification information for specifying the remittee account). The remittance information transmitted from the remitter terminal 11 to the center apparatus 13 sometimes contains a plurality of requests of remittance transactions. In addition to the above information, a remitter account can be added thereto but is described later.

Further, the output unit 112 outputs information (containing information transmitted by the financial agency apparatus 12 and transferred by the center apparatus 13) transmitted from the center apparatus 13.

The financial agency apparatus 12 performs remittance transaction in accordance with the remittance request information prepared by the center apparatus 13 on the basis of remittance information from the remitter. In the embodiment, the financial agency apparatus 12 includes two processing units one of which processes remittance request information in real time transaction and the other processes remittance request information in file transmission transaction. Detailed description of practical remittance transaction based on the remittance request information in the financial agency apparatus is omitted in this specification.

The center apparatus 13 includes an input unit 131, an output unit 132, an optimization unit 133 and a remittance request information preparation unit 134 and further includes various recording units including a customer data recording unit 135, a transaction term recording unit 136, a charge recording unit 137, an additional information recording unit 138 and an entry recording unit 139 connected thereto.

The customer data recording unit 135 records and manages information concerning users of this system and stores information concerning a name, an address, customer identification information, set information of confirmation request described later, one or more accounts held by the user and the like for each user.

The set information of confirmation request is set information relative to contents of information of the confirmation request transmitted by the center apparatus 13 to the remitter and is previously set by the remitter. Detailed description thereof is made later.

The information concerning the account contains financial agency identification information for identifying a financial agency, branch office identification information for identifying a branch office or a business office of a financial agency specified by the financial agency identification information, kind-of-account identification information for specifying a kind of account and account identification information for specifying an account.

The term recording unit 136 manages a transmission term of remittance request information transmitted to the financial agency apparatus 12 in order to receive money in an account of a remittee on a certain receipt date. The term recording unit stores the transmission term of the remittance request information for its own financial agency and other financial agency in each service for each financial agency having the financial agency apparatus and for each remittance transaction method.

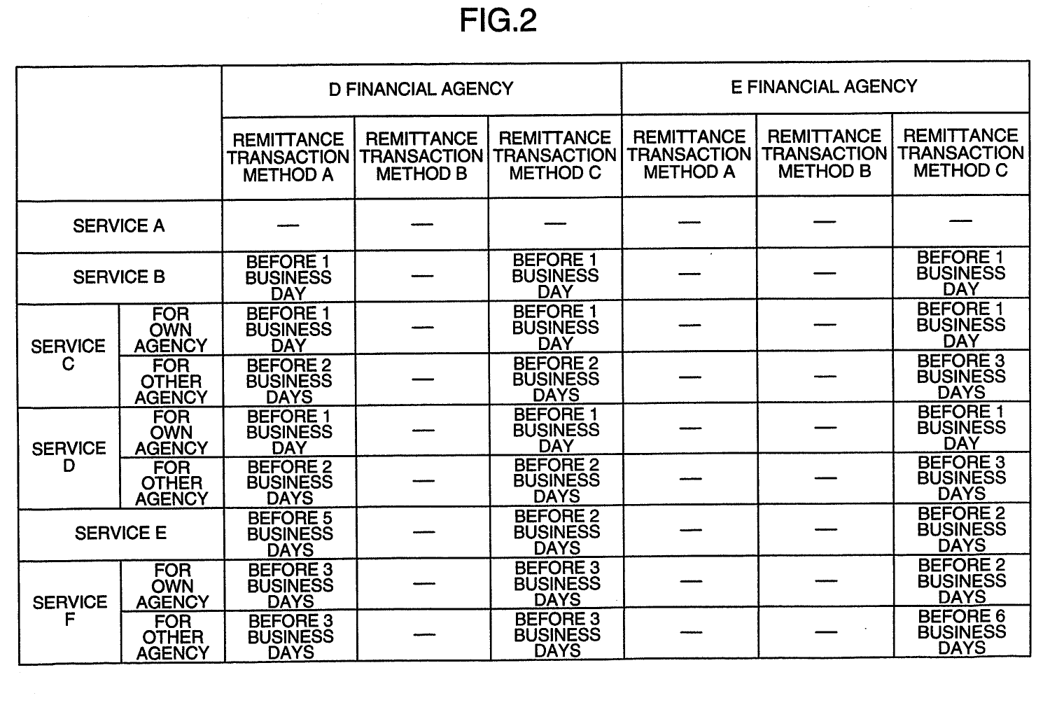

FIG. 2 shows a definite example of the remittance terms of the remittance request information managed by the term recording unit 136. In FIG. 2, transmission terms of the remittance request information are shown for each service when the remittance transaction methods A, B and C are used in D and E financial agencies. The remittance transaction methods A and C make remittance by means of file transmission processing and the remittance transaction method B makes remittance by means of real-time transaction processing. A difference in term for the service (e) between the remittance transaction methods A and C is caused by different networks constituting a transmission route of the file transmission remittance request information.

Further, for its own financial agency and other financial agency of services (c), (d) and (f), the transmission term is different depending on whether the remittee account of remittance requested by the remittance request information resides in the remitter financial agency or not, that is, whether transfer of remittance is made within the same financial agency or not. In FIG. 2, hyphen means impossible to utilize.

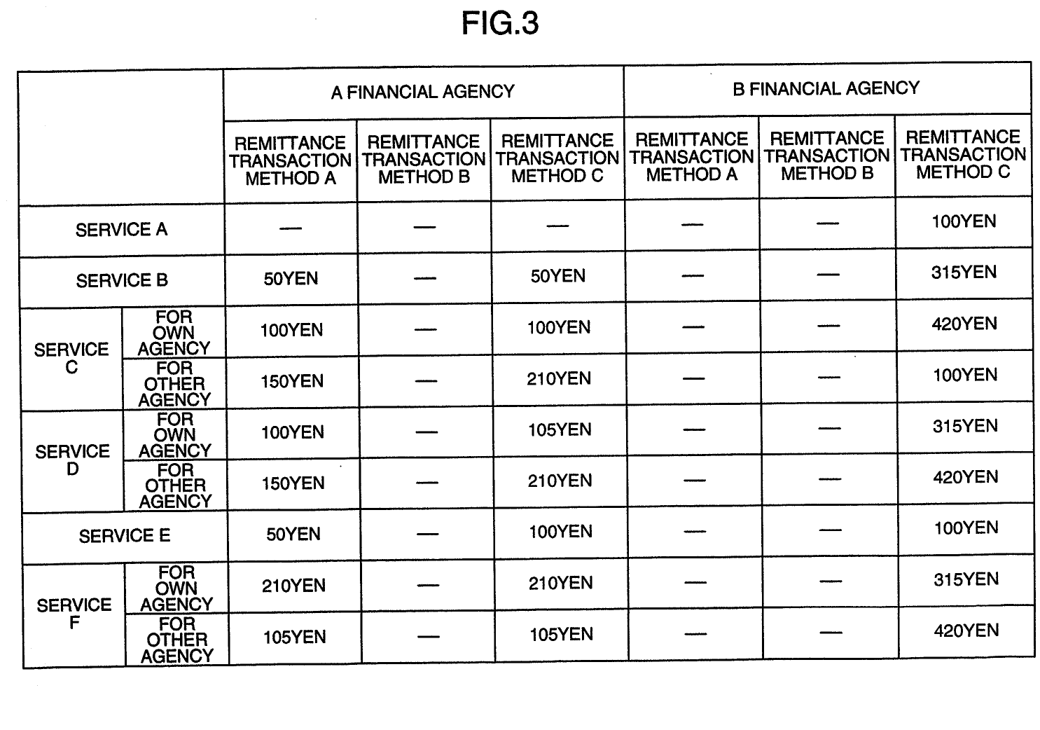

The charge recording unit 137 stores charges for remittance classified in accordance with financial agencies, services and destination of remittance including its own financial agency and other financial agency. FIG. 3 shows a definite example thereof. Terms used in FIG. 3 are the same as those of FIG. 2 showing the definite example of the term recording unit 136 and accordingly description thereof is omitted.

The additional information recording unit 138 is a recording unit for recording additional information. The additional information is information required to be inputted when the electronic fund transfer system is utilized to request the financial agency to make remittance, that is, the additional information is information other than remittance information inputted from the remitter terminal 11 by the remitter. The remittance request information is composed of remittance information and additional information. The additional information recording unit 138 includes a table for each customer and manages the information by means of the tables. Further, as described above, the remittance information contains receipt date information, remittance amount information and remittee account information in addition to customer identification information of the remitter.

Further, in the embodiment, the transmission processing methods A, B and C of the remittance request are described by way of example, while the additional information in these transmission processing methods is different for each transmission processing method and accordingly the additional information recording unit manages additional information items for each transmission processing method.

Further, it is needless to say that information requested to be inputted as additional information is classified into information items to be stored and managed for each remitting financial agency.

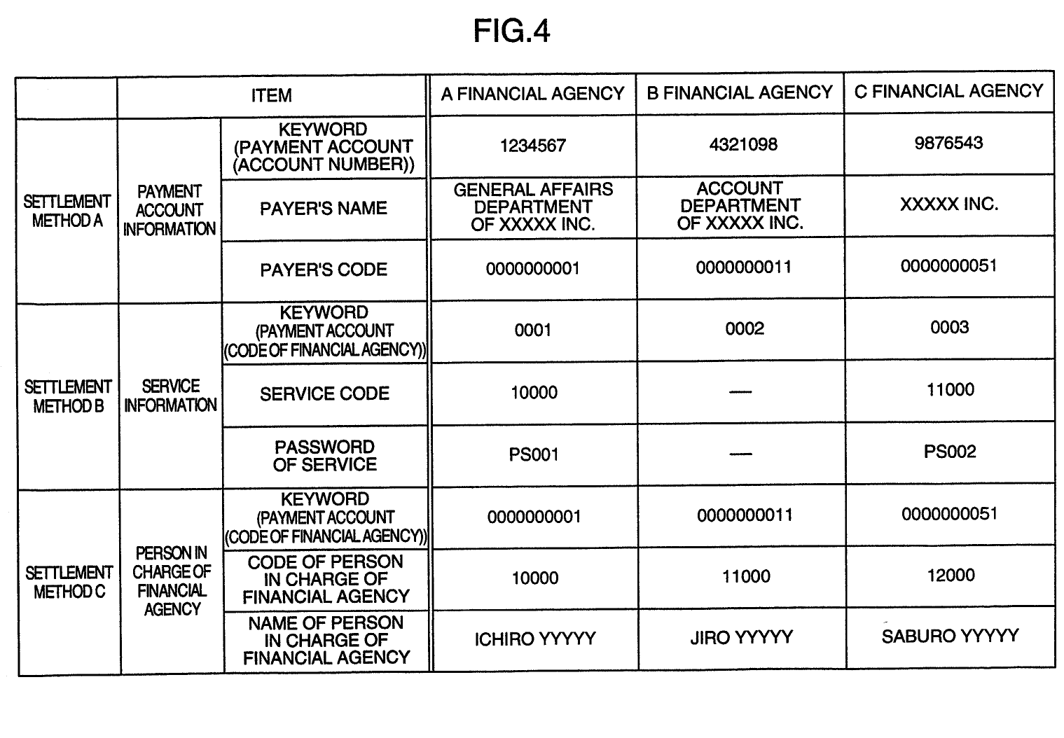

FIG. 4 shows a definite example of the additional information stored in the additional information recording unit 138.

The additional information recording unit 138 manages information items to be contained in the remittance request information for each remittance transaction method and stores data (additional information) corresponding to the information items for each customer. The additional information is information used when the center apparatus 13 prepares the remittance request information. The remittance request information transmitted from the center apparatus 13 to the financial agency apparatus 12 has contents different depending on its remittance transaction method, so that the information items contained in the remittance request information when a certain remittance transaction method is performed is different from those when other remittance transaction method is performed.

Further, the additional information recording unit 138 stores additional information for each of additional information items. For example, when a customer code of a certain customer in a certain financial agency and a service code set by the financial agency are required as additional information items, the data of the customer code and the service code are named as the additional information items. The additional information is stored in corresponding manner to the financial agency, the customer, the information items and the remittance transaction method.

The center apparatus 13 prepares the remittance request information on the basis of the information items and data corresponding to the information items and transmits the remittance request information to the financial agency apparatus 13. For example, when the information items required in utilization of the remittance transaction method are a name of a remitter, an account information of a remitter, a remittance amount and a code of remitter financial agency, the center apparatus 13 prepares the remittance request information on the basis of the remittance information transmitted from the remitter terminal 11 and the additional information stored in the additional information recording unit 138.

In the transmission processing method A, an account number of a payment account, a remitter's name and a remitter's code are designated as the additional information items. The remitter's code is assigned to a customer by the financial agency.

In the transmission processing method B, a code of the remitting financial agency managing the remitter's account, a service code indicating a kind of service of the remittance transaction requested by the customer and a password for the service code are designated.

In the transmission processing method C, a code of the remitting financial agency, a name of a person in charge of the remitting financial agency and a code corresponding to the name of the person in charge are designated.

The entry recording unit 139 stores remittance information transmitted from the remitter terminal 11. The remittance information is once recorded in the entry recording unit 139. The recorded remittance information and information stored in each of the customer data recording unit 135, the term recording unit 136 and the charge recording unit 137 are used to specify a most profitable combination (remittance transaction method) of a remitter account and a transmission processing method of the remittance request information. Further, the entry recording unit 139 may store the remittance information temporarily and may preserve and manage the prepared remittance request information as a history.

The input unit 131 receives information transmitted from the remitter terminal 11 or the financial agency apparatus 12 and the output unit 132 outputs predetermined information to the remitter terminal 11 or the financial agency apparatus 12.

The optimization unit 133 has the function 141 of extracting a remitter account, the function 142 of extracting a remittance transaction method and the function 143 of specifying a remittance transaction method.

The extraction function 141 of the remitter account extracts account information corresponding to customer identification information from the customer data recording unit 135 on the basis of the customer identification information contained in the remittance information. The extraction function 142 of the remittance transaction method extracts a combination (remittance transaction method) of account information that can be received to the remittee account on the receipt date and the transmission processing method of the remittance request information on the basis of the account information extracted by the remitter account extraction function 141, the receipt date information and the kind-of-service information contained in the remittance information and the transmission term of the remittance request information stored in the term recording unit 136. The remittance transaction method specifying function 143 specifies a most profitable one of the extracted remittance transaction methods on the basis of charge information stored in the charge recording unit 137.

The remittance request information preparation unit 134 retrieves information and format required for the remittance transaction method specified by the optimization unit 133 from the additional information recording unit 138 and prepares the remittance request information in accordance with the retrieval result to supply it to the output unit 132.

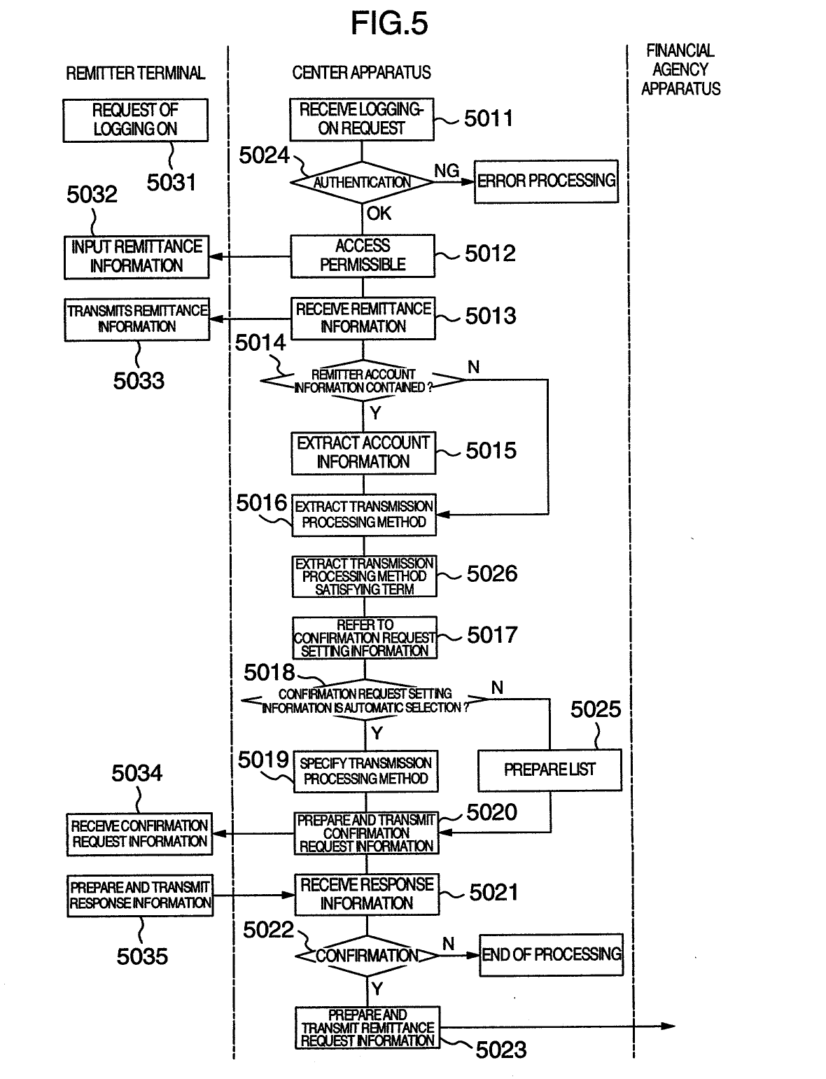

FIG. 5 is a flow chart explaining processing of the embodiment in the fund transfer system of FIG. 1.

When the remitter makes a request of logging-on to the center apparatus 13 by means of the remitter terminal 11 (step 5031), the center apparatus 13 makes predetermined authentication in response to the access request (step 5024). The authentication method may use any method. In step 5024, when the authentication is unsuccessful, the center apparatus treats it as an error and ends this processing. Further, retrial may be requested.

When the remitter is confirmed as being a true person in question, the center apparatus 13 receives remittance information from the remitter terminal 11 (step 5013) and judges whether information for designating an account of the remitter is contained in the remittance information or not (step 5014).

When a specific account is not specified as the remitter account, the center apparatus extracts the account information corresponding to customer identification information of the remitter contained in the remittance information from the customer data recording unit 135 on the basis of the customer identification information (step 5015). When the remitter account is specified, the processing proceeds to step 5016.

Then, the center apparatus 13 extracts a transmission processing method (for each account information when a plurality of account information items are extracted in step 5015) of remittance request information satisfying the condition that payment of money can be made to an account specified as a receipt account on a date specified by receipt date information on the basis of financial agency identification information contained in the account information (each account information when a plurality of account information items are extracted) extracted in step 5015, receipt date information and kind-of-service information contained in the remittance information and date information stored in the term recording unit 136 (step 5026).

Then, when the center apparatus 13 transmits a confirmation request to the remitter terminal 11 in step 5020 described later, the center apparatus 13 refers to, as the confirmation request, confirmation request setting information set previously by the remitter and relating to whether a single transmission processing method (the account information and the transmission processing method when a plurality of account information items are extracted in step 5015) is transmitted or a list in which a plurality of transmission processing methods are enumerated is transmitted, from the customer data recording unit 135 to decide a kind of the confirmation request on the basis of the set contents (step 5017).

In the embodiment, the confirmation request is information indicating whether, when the center apparatus 13 proposes a predetermined transmission processing method (the account information and the transmission processing method when a plurality of account information items are extracted in step 5015) to the remitter, a single transmission processing method (the account information and the transmission processing method when a plurality of account information items are extracted in step 5015) selected automatically by the center apparatus 13 is displayed or a plurality of transmission processing methods (the account information and the transmission processing method when a plurality of account information items are extracted in step 5015) enumerated in order of advantage in view of economical point are displayed.

The decision of the kind of confirmation request described above is to decide the former method or the latter method of transmitting the confirmation request.

Further, in the case of the latter method, the remitter can designate a transmission processing method (the account information and the transmission processing method when a plurality of account information items are extracted in step 5015) from candidates of the transmission processing methods (the account information and the transmission processing method when a plurality of account information items are extracted in step 5015) enumerated by the center apparatus 13.

The confirmation request setting information shows a kind of the confirmation request selected and designated previously by the customer.

The center apparatus 13 searches the charge recording unit 137 to specify a most profitable transmission processing method (the account information and the transmission processing method when a plurality of account information items are extracted in step 5015) from the transmission processing methods extracted in step 5026 when the kind of the confirmation request is automatic selection in step 5018 (step 5019). When there is no method satisfying the condition in step 5019, it is treated as error and this processing is ended.

The center apparatus 13 transmits confirmation request information for confirming whether the transmission processing method (the account information and the transmission processing method when a plurality of account information items are extracted in step 5015) specified in step 5019 can be utilized or not to the remitter terminal 11 (step 5020). The confirmation request information is to display the single transmission processing method (the account information and the transmission processing method when a plurality of account information items are extracted in step 5015) specified among the confirmation request kinds.

When the confirmation request kind is selection by the remitter, the center apparatus 13 sorts the transmission processing methods extracted in step 5016 in order of advantage in view of economical point (step 5025) and transmits the sorted list as the confirmation request information to the remitter terminal 11 (step 5020).

The remitter terminal 11 receives the confirmation request information in step 5020 and transmits response information to the center apparatus 13 in response to the remitter's input. The response information indicates whether utilization of the transmission processing method (the account information and the transmission processing method when a plurality of account information items are extracted in step 5015) indicated in the confirmation request is approved or not in case of the confirmation request for the customer in the automatic selection setting and indicates one of the listed transmission processing methods (the account information and the transmission processing method when a plurality of account information items are extracted in step 5015) in case of the customer in the customer selection setting.

The center apparatus 13 extracts the additional information item and the additional information stored in corresponding manner to the remittance transaction method (in this case transmission processing method even if a plurality of account information items are extracted) specified by the response information from the additional information recording unit 138 in case where the response information is “remittance” (automatic selection) or in case where a specific remittance transaction method (the account information and the transmission processing method when a plurality of account information items are extracted in step 5015) is shown (customer selection).

The center apparatus 13 then extracts customer data of the remitter stored in corresponding manner to the information items in the customer data recording unit 15 and prepares the remittance request information on the basis of the extracted customer data of the remitter and information stored in corresponding manner to the remittance transaction method (in this case, transmission processing method even if a plurality of account information items are extracted in step 5015) specified by the response information in the additional information recording unit 138 to transmit the remittance request information to the financial agency apparatus 12 (step 5023) and end this processing.

With the above processing, the remitter can reduce operation for selecting the transmission processing method advantageous in view of a cost such as a charge within a term of the remittance request and can make remittance without consciousness of difference of the transmission processing method.

It will be further understood by those skilled in the art that the foregoing description has been made on embodiments of the invention and that various changes and modifications may be made in the invention without departing from the spirit of the invention and scope of the appended claims.

What is claimed is:

1. A remittance instruction method of transmitting remittance request information to a financial agency apparatus on the basis of remittance information transmitted from a remitter terminal in a center apparatus including recording units connected to said remitter terminal and said financial agency apparatus, wherein said center apparatus comprises a first recording unit for storing customer identification information for identifying a customer and account identification information possessed by the customer so that said customer identification information corresponds to said account identification information, a second recording unit for storing, for each financial agency, a transmission term of remittance request information to said financial agency apparatus for each transmission processing method which is a method of transmitting said remittance request information to said financial agency apparatus, and a third recording unit for storing, for each financial agency, charge required for remittance request by each transmission processing method, and said center apparatus comprises receiving said remittance information containing said customer identification information, a remittance amount desired to be remitted by said remitter, a receipt date which is a time limit date of payment by the remittance, and a remittee account to which remittance is made, extracting an account possessed by the customer identified by said customer identification information from said first recording unit on the basis of said customer identification information, extracting transmission processing methods capable of making remittance to said remittee account from said extracted account until said receipt date on the basis of the transmission term stored in said second recording unit, and outputting one of said extracted transmission processing methods on the basis of the charge stored in said third recording unit.

2. A remittance instruction method according to claim 1, wherein said center apparatus includes a fourth recording unit for storing said transmission processing method and additional information which is information required for remittance request in each transmission processing method in corresponding manner to each customer, and said center apparatus extracts additional information stored in corresponding manner in said fourth recording unit on the basis of said outputted transmission processing method and prepares remittance request information on the basis of said extracted additional information and said remittance information to transmit said remittance request information to said financial agency apparatus.

3. A remittance instruction method according to claim 1, wherein a plurality of accounts are extracted in said account extracting step.

4. A remittance instruction method according to claim 3, wherein said outputting of said transmission processing method is made for each of said plurality of extracted accounts.

5. A remittance instruction method according to claim 4, said center apparatus includes a fourth recording unit for storing said transmission processing method and additional information which is information required for remittance request in each transmission processing method in corresponding manner to each customer, and said center apparatus receives designated one of said transmission processing methods outputted for said extracted accounts and extracts said additional information stored in corresponding manner in said fourth recording unit to said designated transmission processing method, preparing remittance request information on the basis of said extracted additional information and said remittance information to transmit said remittance request information to said financial agency apparatus.
